(19) United States
(12) Patent Application Publication
(10) Pub. No.: US 2026/0131314 A1
(43) Pub. Date: May 14, 2026

(54) HIGHLY ACTIVE Ag/Al2O3 CATALYST AND PREPARATION METHOD THEREOF

(71) Applicant: GWANGJU INSTITUTE OF SCIENCE AND TECHNOLOGY, Gwangju (KR)

(72) Inventors: Sung Bong KANG, Gwangju (KR); Sang Woo BYUN, Gwangju (KR); Hyeon Woo SHIN, Gwangju (KR)

(21) Appl. No.: 19/263,376

(22) Filed: Jul. 8, 2025

(30) Foreign Application Priority Data
Nov. 14, 2024 (KR) 10-2024-0161941

(51) Int. Cl. B01J 23/50; B01D 53/86; B01J 21/04; B01J 35/70; B01J 37/00; B01J 37/04; B01J 37/08

(52) U.S. Cl. CPC B01J 23/50; B01D 53/8634; B01D 53/864; B01J 21/04; B01J 35/70; B01J 37/0036; B01J 37/04; B01J 37/082; B01J 2235/15

(57) ABSTRACT

The present inventive concept relates to a method for preparing a silver-alumina catalyst using a solid-state impregnation method. According to the inventive concept, when Ag is supported on a γ-Al₂O₃ support, the Ag precursor and γ-Al₂O₃ are ground and mixed in the solid-state without the use of water, followed by calcination. As a result, the molten salt derived from the metallic silver (Ag) precursor in the calcination step exhibits low mobility, which limits its interaction with surface defects such as surface hydroxyl groups on γ-Al₂O₃. This limited interaction leads to the formation of bulk metallic Ag species, which exhibit superior oxidation performance in CO and NH₃ oxidation reactions compared to Ag oxides present in Ag_{w}/γ-Al₂O₃ catalysts prepared by the conventional wet impregnation method.

### CROSS-REFERENCE TO RELATED PATENT APPLICATION

This application claims the benefit of Korean Patent Application No. 10-2024-0161941, filed on Nov. 14, 2024, in the Korean Intellectual Property Office, the disclosure of which is incorporated herein in its entirety by reference.

### BACKGROUND

### 1. Field of the Inventive Concept

The present inventive concept relates to a method for preparing a CO and NH₃ oxidation catalyst, and more particularly, to a highly active silver-alumina (Ag/Al₂O₃) catalyst and a method for preparing the same.

### 2. Description of the Related Art

Heterogeneous catalysts are critically important in most chemical processes and are involved in more than 80% of industrial reactions. The development of highly active catalysts is essential for improving the economic efficiency of the chemical industry, and since catalysts play a key role as core materials, extensive research has been conducted to enhance their stability and activity.

Meanwhile, silver-alumina (Ag/γ-Al₂O₃) catalysts are widely used in environmental applications, where the valence state of surface Ag species has a significant effect on catalytic activity. Specifically, Ag oxide species (such as isolated Ag⁺ ions and Agₙ^{δ+} clusters) are known to serve as active phases in hydrocarbon-selective catalytic reduction (HC-SCR) of NOₓ, whereas metallic Ag species (including Agₙ⁰ clusters and Ag nanoparticles) exhibit catalytic activity in the oxidation and removal of air pollutants such as ammonia (NH₃), carbon monoxide (CO), and formaldehyde (HCHO). Accordingly, controlling the valence state of surface Ag is essential for designing efficient Ag-based catalysts tailored to specific reactions.

Conventional silver-alumina catalysts have been prepared using traditional wet impregnation methods, however, in such cases, strong interactions between Ag species and surface hydroxyl groups (—OH) on γ-Al₂O₃ make it difficult to form metallic Ag species at low Ag loadings. To overcome this limitation, strategies such as increasing the Ag loading, applying hydrogen pretreatment, or introducing electron-donating promoters have been employed, however, these approaches often involve trade-offs between cost and catalytic performance.

Accordingly, there is a need for a new method to improve the performance of silver-alumina catalysts in a cost-effective manner.

### SUMMARY OF THE INVENTIVE CONCEPT

The present inventive concept has been made in an effort to solve the above-described problems associated with prior art, and an object of the present inventive concept is to provide a highly active silver-alumina catalyst.

Another object of the present inventive concept is to provide a method for preparing the highly active silver-alumina catalyst.

In order to achieve the above-mentioned objects, one aspect of the present inventive concept provides a highly active silver-alumina catalyst. The highly active silver-alumina catalyst may comprise crystalline silver (Ag) formed on a gamma alumina support and may have an Ag⁰/Ag⁺ ratio of 0.9 or higher.

The content of Ag in the catalyst may range from 0.1 to 5 wt. %.

The catalyst may have a metallic Ag phase.

The catalyst may have d-spacings in the ranges of 0.203 nm to 0.205 nm and 0.235 nm to 0.237 nm.

The catalyst may exhibit diffraction peaks at 38° to 39°, 44° to 45°, 64° to 65°, and 77° to 78° in X-ray diffraction analysis.

The catalyst may exhibit CO and NH₃ oxidation performance of 50% or higher at 300° C. when the Ag content is 1 wt. %.

Another aspect of the present inventive concept provides a method for preparing the highly active silver-alumina catalyst. The method for preparing the highly active silver-alumina catalyst may comprise the steps of: grinding and mixing gamma alumina (γ-Al₂O₃) and a metallic silver (Ag) precursor together in the solid phase; and calcination the mixture of gamma alumina and the metallic silver (Ag) precursor at a temperature above the melting point of the metallic silver (Ag) precursor to prepare a catalyst comprising crystalline silver (Ag) formed on a gamma alumina support.

The content of the metallic silver (Ag) precursor may range from 0.1 wt. % to 5 wt. % based on the total weight of the mixture.

The metallic silver (Ag) precursor may be converted into a molten salt in the calcination step.

The method for preparing the catalyst may result in a smaller reduction in the content of terminal hydroxyl groups on gamma alumina than a water-based wet impregnation method.

The crystalline silver (Ag) formed in the calcination step may be present in a metallic phase and may have an Ag⁰/Ag⁺ ratio of 0.9 or higher.

The method for preparing the catalyst may further comprise the step of drying the mixture of gamma alumina and the metallic silver (Ag) precursor prior to calcination.

The calcination may be carried out under static air conditions.

The calcination may be carried out at a temperature ranging from 450° C. to 600° C.

The method for preparing the catalyst may further comprise the step of pelletizing the calcinated catalyst powder.

According to the present inventive concept, when Ag is impregnated on a γ-Al₂O₃ support, the Ag precursor and γ-Al₂O₃ used are ground and mixed in the solid-state without the use of water, followed by calcination. As a result, the molten salt derived from the metallic silver (Ag) precursor in the calcination step exhibits low mobility, which limits its interaction with surface defects such as surface hydroxyl groups on γ-Al₂O₃. This limited interaction leads to the formation of bulk metallic Ag species, which exhibit superior oxidation performance in CO and NH₃ oxidation reactions compared to Ag oxides present in Ag_{w}/γ-Al₂O₃ catalysts prepared by the conventional wet impregnation method.

### BRIEF DESCRIPTION OF THE DRAWINGS

FIG. 1 is a schematic diagram of a solid-state impregnation method according to one embodiment of the present inventive concept, illustrating the interaction mechanism between Ag and surface hydroxyl groups on γ-Al₂O₃ in the calcination step.

FIG. 2 is a schematic diagram of a wet impregnation method according to a Comparative Example, illustrating the interaction mechanism between Ag and surface hydroxyl groups on γ-Al₂O₃ in the calcination step.

FIG. 3 illustrates the interaction between metallic Ag and surface hydroxyl groups (—OH) based on surface infrared spectra at different calcination temperatures of silver-alumina catalysts prepared in one Preparation Example of the present inventive concept and one Comparative Example, excluding the spectra of pure Al₂O₃ before Ag impregnation.

FIG. 4 shows the 1H MAS NMR spectra of silver-alumina catalysts prepared in one Preparation Example of the present inventive concept and one Comparative Example, along with that of pure Al₂O₃.

FIG. 5 shows transmission electron microscope (TEM) images of silver-alumina catalysts prepared in one Preparation Example of the present inventive concept and one Comparative Example.

FIG. 6 shows particle size distribution graphs of silver (Ag) particles in silver-alumina catalysts prepared in one Preparation Example of the present inventive concept and one Comparative Example.

FIG. 7 shows the X-ray diffraction (XRD) spectra of silver-alumina catalysts prepared in one Preparation Example of the present inventive concept and one Comparative Example, along with that of pure γ-Al₂O₃ catalyst.

FIG. 8 shows the absorbance at different wavelengths measured by UV-Vis spectroscopy and the Ag⁰/Ag⁺ ratio in Ag/γ-Al₂O₃ catalysts prepared in one Preparation Example of the present inventive concept and one Comparative Example.

FIG. 9 is a graph showing the CO oxidation performance of silver-alumina catalysts prepared in one Preparation Example of the present inventive concept and one Comparative Example, indicating the CO conversion (%) as a function of temperature.

FIG. 10 is a graph showing the NH₃ oxidation activity performance of silver-alumina catalysts prepared in one Preparation Example of the present inventive concept and one Comparative Example, indicating the NH₃ conversion (%) as a function of temperature.

FIG. 11 is a graph showing the temperature (T₅₀) at which 50% CO conversion is achieved for silver-alumina catalysts prepared in one Preparation Example of the present inventive concept and one Comparative Example.

### DETAILED DESCRIPTION OF THE INVENTIVE CONCEPT

Hereinafter, preferred embodiments of the present inventive concept will be described in more detail with reference to the accompanying drawings in order to provide a more specific description of the inventive concept. However, the present inventive concept is not limited to the embodiments described herein and may be embodied in other forms.

Throughout this specification, when a part is referred to as “including” a certain component, it is to be understood that, unless explicitly stated otherwise, the part may further include other components and does not exclude the presence of other components.

As used herein, the terms “about” and “substantially” are used to indicate a degree of approximation to the stated value, including any material tolerance that may exist in the relevant context. These terms are intended to aid in the understanding of the present disclosure and to prevent unscrupulous infringers from unfairly exploiting the disclosure of precise or absolute values.

It will be understood that, when an element such as a layer, region, or substrate is referred to as being “on” another element, the element may be directly on the other element or may have one or more intervening elements therebetween.

It will be understood that, although the terms “first”, “second”, and the like may be used herein to describe various elements, components, regions, layers, and/or sections, such elements, components, regions, layers, and/or sections should not be limited by these terms.

In the present specification, “Agₛ/γ-Al₂O₃” refers to an Ag/γ-Al₂O₃ catalyst prepared by a solid-state impregnation method, and “Ag_{w}/γ-Al₂O₃” refers to an Ag/γ-Al₂O₃ catalyst prepared by a wet impregnation method.

Method for Preparing Agₛ/γ-Al₂O₃ Catalyst Using Solid-State Impregnation Method

One aspect of the present inventive concept provides a method for preparing an Ag/γ-Al₂O₃ catalyst using a solid-state impregnation method.

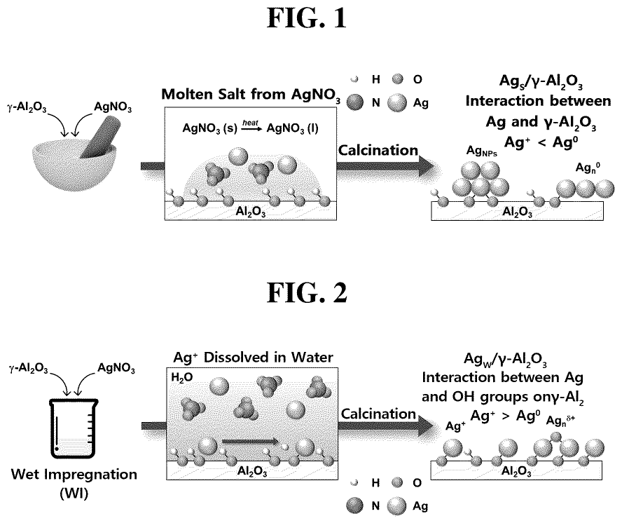

FIG. 1 is a schematic diagram of a solid-state impregnation method according to one embodiment of the present inventive concept, illustrating the interaction mechanism between Ag and surface hydroxyl groups on γ-Al₂O₃ in the calcination step.

Referring to FIG. 1, the method for preparing an Ag/γ-Al₂O₃ catalyst according to the present inventive concept may comprise the steps of:
grinding and mixing gamma alumina (γ-Al₂O₃) and a metallic silver (Ag) precursor together in a solid phase; and
calcination the mixture of gamma alumina and a metallic silver (Ag) precursor at a temperature above the melting point of the metallic silver (Ag) precursor to prepare a catalyst comprising crystalline silver (Ag) formed on a gamma alumina support.

Next, the method for preparing an Ag/γ-Al₂O₃ catalyst using the solid-state impregnation method according to the present inventive concept will be described in detail step by step.

First, gamma alumina and a metallic silver (Ag) precursor are ground and mixed together in the solid phase.

The key difference between solid-state impregnation and wet impregnation lies in the presence or absence of H₂O during the synthesis process. In the solid-state impregnation method, no solvent is used; instead, gamma alumina and the metallic silver (Ag) precursor in the solid phase are physically ground and mixed.

At this time, any silver (Ag)-containing precursor known in the art may be used as the metallic silver precursor. For example, silver nitrate (AgNO₃) may be used, but is not limited thereto.

The content of the metallic silver (Ag) precursor is preferably 0.1 wt. % to 5 wt. % based on the total weight of the mixture, and more preferably 0.5 wt. % to 1.5 wt. %. Within this range, the catalyst can exhibit excellent catalytic oxidation performance for CO and NH₃.

The method may further comprise the step of drying the mixture of gamma alumina and the metallic silver (Ag) precursor prior to calcination. The drying may be carried out at a temperature ranging from 70° C. to 85° C.

Next, the mixture of gamma alumina and the metallic silver (Ag) precursor is calcinated at a temperature above the melting point of the metallic silver (Ag) precursor. Specifically, the calcination may be carried out under static air conditions at a temperature above the melting point of the metallic silver (Ag) precursor, for example, at a temperature ranging from 450° C. to 600° C.

When the temperature reaches the melting point of the metal precursors in the calcination step, the metal precursors are converted into molten salts, as illustrated in FIG. 1.

In the solid-state impregnation method, the mobility characteristic of the metal precursor is a key factor in determining the formation of surface Ag phases. In this method, the metallic silver (Ag) precursor, such as AgNO₃ precursor, has a melting point of 212° C. and is converted into a molten salt in the calcination step, where its mobility becomes restricted. Specifically, the molten salt derived from the metallic silver (Ag) precursor in the calcination step may partially interact with surface defects such as surface hydroxyl groups on γ-Al₂O₃; however, due to its low mobility, strong interactions do not occur. Furthermore, since the solid-state impregnation method does not involve H₂O, the dispersion of Ag species is suppressed, leading to the formation of bulk Ag species with limited interaction with the surface hydroxyl groups on γ-Al₂O₃. These bulk Ag species, which lack metal-support interactions, thermodynamically favor the formation of a metallic phase over an oxidized phase. As a result, the Agₛ/γ-Al₂O₃ catalyst predominantly forms bulk metallic Ag in the form of Ag clusters or Ag nanoparticles. Thereafter, the calcinated catalyst powder may optionally be subjected to an additional pelletizing step. Although the size of the resulting pellets is not particularly limited, it is preferable for the pellets to have a size of 30-40 mesh (425-600 μm) to achieve excellent catalytic performance.

FIG. 2 is a schematic diagram of a wet impregnation method according to a Comparative Example, illustrating the interaction mechanism between Ag and surface hydroxyl groups on γ-Al₂O₃ in the calcination step.

Referring to FIG. 2, in the catalyst synthesized by the wet impregnation method (denoted as Ag_{w}/γ-Al₂O₃), the metallic silver (Ag) precursor dissolved in H₂O, such as AgNO₃ precursor, exists in two forms (i.e., Ag⁺ ions and anions, e.g., NO₃⁻ ions in the case of AgNO₃ precursor). During the impregnation process, Ag⁺ ions interact particularly with electronic defect sites or surface hydroxyl groups (—OH) on the support, leading to the formation of metal-support interactions. In particular, γ-Al₂O₃, a non-reducing metal oxide support, can promote the interaction between Ag⁺ ions and surface hydroxyl groups, leading to the formation of Ag—O—Al bonds. These bonds are formed through the exchange of hydrogen from the hydroxyl groups with Ag⁺ ions, resulting primarily in isolated Ag⁺ ions or Agₙ^{δ+} clusters. Upon calcination, these species are converted into Ag oxides, which may result in decreased catalytic oxidation performance when used as catalysts in CO and NH₃ oxidation reactions.

Agₛ/γ-Al₂O₃ Catalyst

Another aspect of the present inventive concept provides an Agₛ/γ-Al₂O₃ catalyst prepared by the solid-state impregnation method.

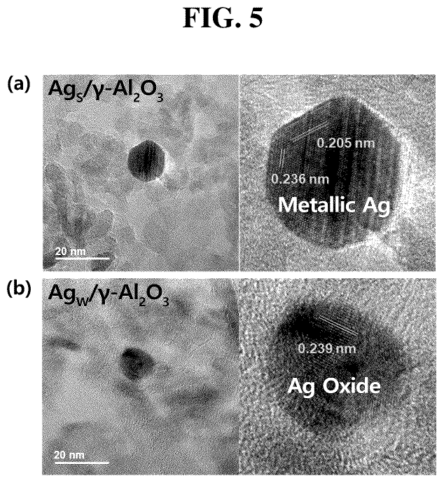

According to the results of the transmission electron microscopy (TEM) analysis shown in FIG. 5, the Agₛ/γ-Al₂O₃ catalyst comprises crystalline silver (Ag) formed on the gamma alumina support. The crystalline metallic Ag particles include the (200) plane with d-spacings in the range of 0.203 nm to 0.205 nm and the (111) plane with d-spacings in the range of 0.235 nm to 0.237 nm.

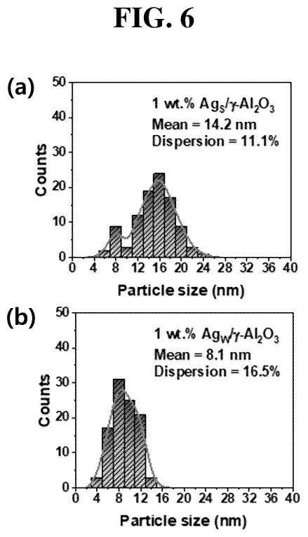

Referring to FIG. 6, the crystalline metallic Ag particles in the Agₛ/γ-Al₂O₃ catalyst may have a mean particle size of 10 nm to 20 nm, and more specifically 13 nm to 15 nm, and the dispersion of Ag within the γ-Al₂O₃ support may range from 10% to 13%.

The content of crystalline metallic Ag in the Agₛ/γ-Al₂O₃ catalyst is preferably 0.1 wt. % to 5 wt. %, and more preferably 0.5 wt. % to 1.5 wt. %. Within this range, the catalyst can exhibit excellent catalytic oxidation performance for CO and NH₃.

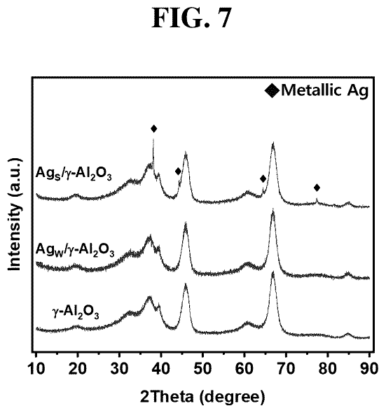

Moreover, according to the results of the X-ray diffraction (XRD) analysis shown in FIG. 7, the Agₛ/γ-Al₂O₃ catalyst may exhibit diffraction peaks at 38° to 39°, 44° to 45°, 64° to 65°, and 77° to 78°, corresponding to the (111), (200), (220), and (311) planes of metallic Ag, respectively.

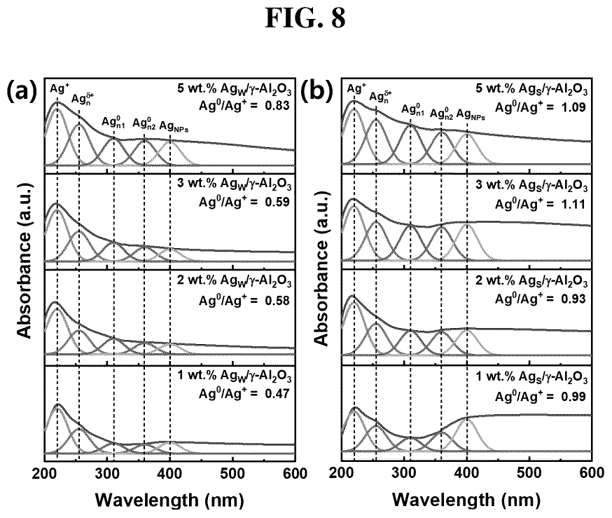

Furthermore, according to the results of the UV-Vis spectroscopy shown in FIG. 8, the Agₛ/γ-Al₂O₃ catalyst may have an Ag⁰/Ag⁺ ratio of 0.9 or higher, and more specifically, in the range of 0.9 to 1.5.

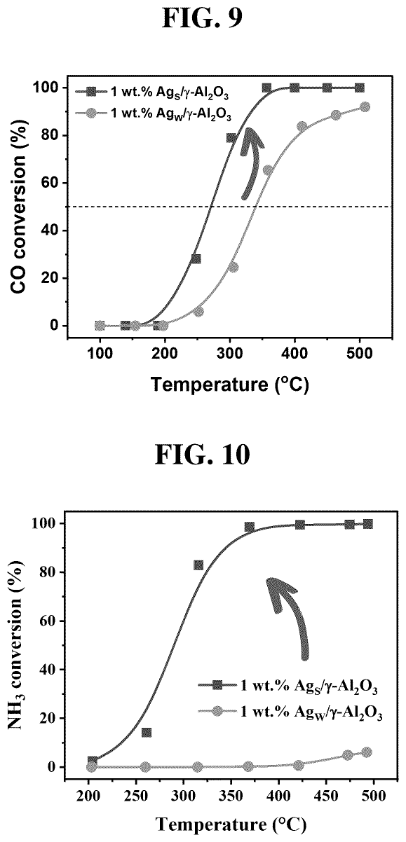

As shown in FIGS. 9 and 10, the Agₛ/γ-Al₂O₃ catalyst exhibits superior catalytic activity in the oxidation of carbon monoxide (CO) and ammonia (NH₃) compared to Ag_{w}/γ-Al₂O₃ catalysts prepared by the conventional wet impregnation method. In particular, the Agₛ/γ-Al₂O₃ catalyst with an Ag content of 1 wt. % can achieve the same catalytic activity at a T₅₀ (the temperature at which 50% CO conversion is achieved) that is 70° C. lower than that of the Ag_{w}/γ-Al₂O₃ catalyst with the same Ag content, indicating enhanced energy efficiency. In addition, even with increasing Ag content, the Agₛ/γ-Al₂O₃ catalyst consistently exhibits a lower T₅₀ than the Ag_{w}/γ-Al₂O₃ catalyst prepared by the conventional wet impregnation method, thereby confirming its superior oxidation performance over the Ag_{w}/γ-Al₂O₃ catalyst.

In particular, the Agₛ/γ-Al₂O₃ catalyst with an Ag content of 1 wt. % can exhibit CO and NH₃ oxidation performance of 50% or higher at 300° C.

According to the present inventive concept, when Ag is supported on a γ-Al₂O₃ support, the Ag precursor and γ-Al₂O₃ used are ground and mixed in the solid-state without the use of water, followed by calcination. As a result, the molten salt derived from the metallic silver (Ag) precursor in the calcination step exhibits low mobility, which limits its interaction with surface defects such as surface hydroxyl groups on γ-Al₂O₃. This limited interaction leads to the formation of bulk metallic Ag species, which exhibit superior oxidation performance in CO and NH₃ oxidation reactions compared to Ag oxides present in Ag_{w}/γ-Al₂O₃ catalysts prepared by the conventional wet impregnation method.

Next, preferred Preparation Examples and Experimental Examples are provided to facilitate understanding of the present inventive concept. However, these examples are presented for illustrative purposes only and are not intended to limit the scope of the present inventive concept.

### Preparation Example 1: Preparation of Silver-Alumina (Agₛ/γ-Al₂O₃) Catalyst Using Solid-State Impregnation Method

A mixture of AgNO₃ (≥99%, Sigma-Aldrich) at 1 wt. % and γ-Al₂O₃ was ground using a mortar and pestle for 4 minutes. The resulting powder was dried overnight at 80° C., followed by calcination at 500° C. for 5 hours under static air conditions in a muffle furnace, with a heating rate of 10° C./min, to prepare the silver-alumina (Agₛ/γ-Al₂O₃) catalyst powder. The calcinated catalyst powder was then pelletized to a size of 30 mesh to 40 mesh (425 μm to 600 μm).

### Preparation Example 2

Silver-alumina (Agₛ/γ-Al₂O₃) catalyst pellets were prepared in the same manner as in Preparation Example 1, except that the content of AgNO₃ used was 2 wt. %.

### Preparation Example 3

Silver-alumina (Agₛ/γ-Al₂O₃) catalyst pellets were prepared in the same manner as in Preparation Example 1, except that the content of AgNO₃ used was 3 wt. %.

### Preparation Example 4

Silver-alumina (Agₛ/γ-Al₂O₃) catalyst pellets were prepared in the same manner as in Preparation Example 1, except that the content of AgNO₃ used was 5 wt. %.

### Comparative Example 1: Preparation of Ag_{w}/γ-Al₂O₃ Catalyst by Wet Impregnation Method

1 wt. % of AgNO₃ was homogeneously dissolved in 200 ml of deionized water, and then γ-Al₂O₃ was added to the AgNO₃ solution. The mixture was vigorously stirred and continuously evaporated at 80° C. After the evaporation was completed, the resulting powder was dried under static air conditions and then calcinated at 500° C. for 5 hours in a muffle furnace, with a heating rate of 10° C./min, to prepare the silver-alumina (Ag_{w}/γ-Al₂O₃) catalyst powder. The calcinated catalyst powder was then pelletized into a size of 30 mesh to 40 mesh (425 μm to 600 μm).

### Comparative Example 2

Silver-alumina (Ag_{w}/γ-Al₂O₃)) catalyst pellets were prepared in the same manner as in Comparative Example 1, except that the content of AgNO₃ used was 2 wt. %.

### Comparative Example 3

Silver-alumina (Ag_{w}/γ-Al₂O₃)) catalyst pellets were prepared in the same manner as in Comparative Example 1, except that the content of AgNO₃ used was 3 wt. %.

### Comparative Example 4

Silver-alumina (Ag_{w}/γ-Al₂O₃)) catalyst pellets were prepared in the same manner as in Comparative Example 1, except that the content of AgNO₃ used was 5 wt. %.

### Experimental Example 1: Surface Infrared Analysis of the Prepared Catalysts

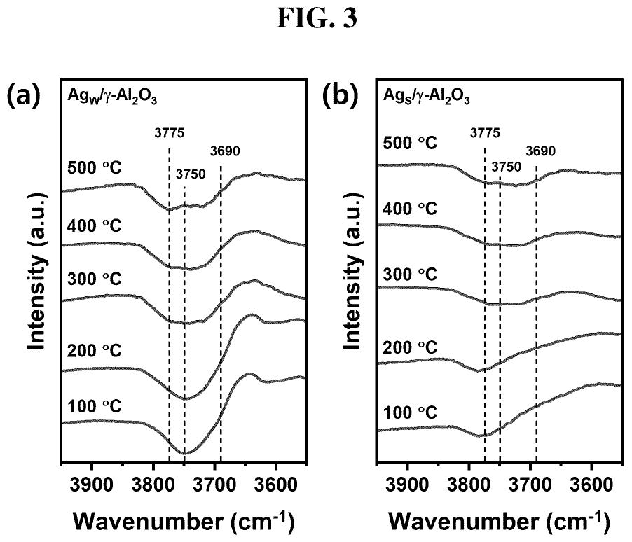

Surface infrared (IR) analysis was performed on the silver-alumina catalysts prepared in Preparation Example 1 and Comparative Example 1 at different calcination temperatures, and the results are shown in FIG. 3.

FIG. 3 illustrates the interaction between metallic Ag and surface hydroxyl groups (—OH) based on surface infrared spectra at different calcination temperatures of silver-alumina catalysts prepared in one Preparation Example of the present inventive concept and one Comparative Example, excluding the spectra of pure Al₂O₃ before Ag impregnation. Specifically, during the interaction between Ag species and surface hydroxyl groups, the negative intensity of OH-related peaks increases. The stretching vibration frequencies of hydroxyl groups are observed as follows: terminal hydroxyl groups at 3800 cm⁻¹ to 3760 cm⁻¹, doubly-bridged hydroxyl groups at 3750 cm⁻¹ to 3725 cm⁻¹, and triply-bridged hydroxyl groups at 3710 cm⁻¹ to 3690 cm⁻¹.

As shown in FIG. 3, the Ag_{w}/γ-Al₂O₃ catalyst prepared in Comparative Example 1 consumed all three types of surface hydroxyl groups through ion exchange prior to the calcination step, with the depletion of terminal hydroxyl groups (at 3775 cm⁻¹) being particularly pronounced upon Ag impregnation. During the wet impregnation process, the terminal hydroxyl groups (—OH) preferentially interact with water-soluble Ag⁺ ions, as evidenced by the decreasing peak intensity with increasing calcination temperature. This observation suggests that the consumption of hydroxyl groups reflects the formation of strong bonds between metallic Ag and terminal hydroxyl groups during the synthesis of the Ag/γ-Al₂O₃ catalyst.

In contrast, the Agₛ/γ-Al₂O₃ catalyst prepared in Preparation Example 1 according to the present inventive concept showed an increase in the negative peak intensity of triply-bridged hydroxyl groups (3690 cm⁻¹) in the temperature range of 200° C. to 300° C., while the terminal hydroxyl groups (3775 cm⁻¹) remained largely unchanged. Considering that the melting point of the Ag precursor, AgNO₃ is 212° C., this result can be interpreted as a consequence of the limited mobility of AgNO₃.

As such, in the conventional wet impregnation method, during the impregnation of Ag into Al₂O₃ in the calcination step, terminal hydroxyl groups (—OH) on Al₂O₃ preferentially interact with water-soluble Ag⁺ ions, resulting in the formation of strong bonds between metallic Ag and the terminal hydroxyl groups. However, in the solid-state impregnation method according to the present inventive concept, there was almost no change in the intensity of the terminal hydroxyl group peak (at 3775 cm⁻¹) in the calcination step, confirming the absence of interaction between the terminal hydroxyl groups (—OH) and the Ag precursor.

### Experimental Example 2: 1H Magic Angle Spinning (MAS) Nuclear Magnetic Resonance (NMR) Spectral Analysis

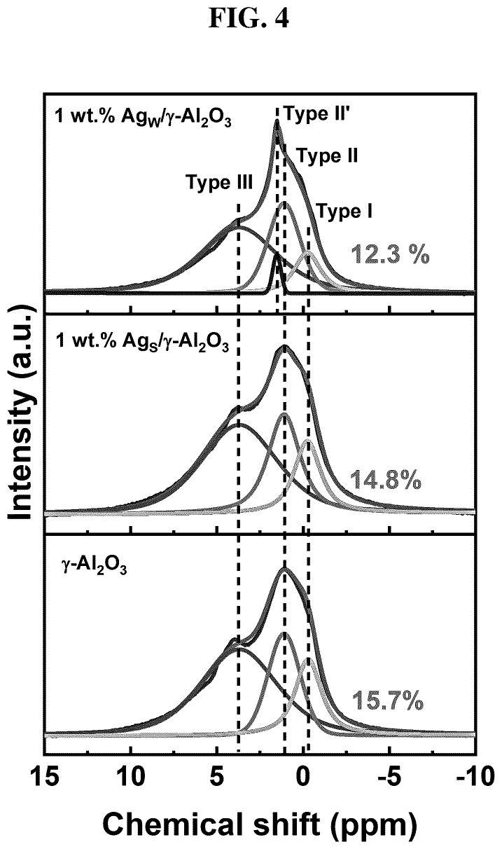

¹H Magic Angle Spinning (MAS) Nuclear Magnetic Resonance (NMR) spectral analysis was performed on the silver-alumina catalysts prepared in Preparation Example 1 and Comparative Example 1, and the results are shown in FIG. 4. For comparison, the ¹H MAS NMR spectrum of pure Al₂O₃ is also presented in FIG. 4.

FIG. 4 shows the ¹H MAS NMR spectra of silver-alumina catalysts prepared in one Preparation Example of the present inventive concept and one Comparative Example, along with that of pure Al₂O₃.

In FIG. 4, the spectrum of Ag/γ-Al₂O₃ was deconvoluted into three peaks observed at chemical shifts of −0.2, 1.1, and 3.8 ppm, which were assigned to terminal hydroxyl groups (HO-μ₁, Type I), doubly-bridged hydroxyl groups (HO-μ₂, Type II), and triply-bridged hydroxyl groups (HO-μ₃, Type III), respectively.

As shown in FIG. 4, compared to pure Al₂O₃, the 1 wt. % Ag_{w}/γ-Al₂O₃ catalyst prepared by the wet impregnation method in Comparative Example 1 exhibited a 3.4% peak decrease in terminal hydroxyl group content, from 15.7% to 12.3%. In contrast, the 1 wt. % Agₛ/γ-Al₂O₃ catalyst synthesized by the solid-state impregnation method according to the present inventive concept showed a smaller decrease of 0.9% peak, from 15.7% to 14.8%, indicating a significantly lower reduction compared to the wet impregnation method. These results clearly demonstrate that the solid-state impregnation method can effectively suppress the formation of strong metal-support interactions (SMSI), due to the limited interaction between terminal hydroxyl groups and Ag species, as consistently observed in Experimental Example 1. The presence of a new distinct peak at approximately 1.5 ppm observed uniquely in the catalyst synthesized by the wet impregnation method. This peak is attributed to the Ag species anchored to the terminal hydroxyl groups of γ-Al₂O₃, indicating that the Ag species formed strong metal-support interactions (SMSI) with these hydroxyl groups.

### Experimental Example 3: Transmission Electron Microscopy (TEM) Analysis

To investigate the morphology of the catalysts, transmission electron microscopy (TEM) was performed on the silver-alumina catalysts prepared in Preparation Example 1 and Comparative Example 1, and the results are shown in FIG. 5. Moreover, the size distribution of Ag particles was measured, and the results are presented in FIG. 6.

FIG. 5 shows transmission electron microscope (TEM) images of silver-alumina catalysts prepared in Preparation Example 1 of the present inventive concept and Comparative Example 1.

FIG. 6 shows particle size distribution graphs of silver (Ag) particles in silver-alumina catalysts prepared in Preparation Example 1 of the present inventive concept and Comparative Example 1.

As shown in FIGS. 5 and 6, the Agₛ/γ-Al₂O₃ catalyst prepared by the solid-state impregnation method in Preparation Example 1 according to the present inventive concept exhibited d-spacings of 0.205 nm and 0.236 nm, corresponding to the (200) and (111) planes, respectively, indicating the formation of crystalline metallic Ag particles. The mean particle size was measured to be 14.2 nm, and the dispersion of Ag within the support was determined to be 11.1%.

In contrast, the Ag_{w}/γ-Al₂O₃ catalyst prepared by the conventional wet impregnation method in Comparative Example 1 exhibited a d-spacing of 0.239 nm, corresponding to the (200) plane of Ag oxides (Ag₂O), indicating the formation of Ag oxide particles. The mean particle size was measured to be 8.1 nm, and the dispersion of Ag within the support was found to be 16.5%.

The formation of such crystalline metallic Ag particles suggests that the solid-state impregnation method effectively suppresses the formation of strong metal-support interactions (SMSI) compared to the wet impregnation method.

### Experimental Example 4: X-Ray Diffraction (XRD) Analysis

To investigate the crystal structure of the catalysts, X-ray diffraction (XRD) analysis was performed on the silver-alumina catalysts prepared in Preparation Example 1 and Comparative Example 1, and the results are shown in FIG. 7.

FIG. 7 shows the X-ray diffraction (XRD) spectra of silver-alumina catalysts prepared in Preparation Example 1 of the present inventive concept and Comparative Example 1, along with that of pure γ-Al₂O₃ catalyst.

As shown in FIG. 7, the Agₛ/γ-Al₂O₃ catalyst prepared by the solid-state impregnation method in Preparation Example 1 according to the present inventive concept exhibited diffraction peaks at 38.1°, 44.4°, 64.4°, and 77.3° corresponding to the (111), (200), (220), and (311) planes of metallic Ag, respectively, indicating a high degree of crystallinity of the metallic Ag species.

In contrast, the Ag_{w}/γ-Al₂O₃ catalyst prepared by the conventional wet impregnation method in Comparative Example 1 did not exhibit any distinct diffraction peaks corresponding to metallic Ag.

Therefore, it was confirmed that the silver-alumina catalyst prepared by the solid-state impregnation method according to the present inventive concept exhibits a high degree of crystallinity of metallic Ag species, in contrast to the silver-alumina catalyst prepared by the wet impregnation method.

### Experimental Example 5: UV-Vis Spectroscopy

In Ag/γ-Al₂O₃ catalysts, the Ag species formed on the surface exhibit different phases depending on their valence states. Accordingly, UV-Vis spectroscopy was performed to gain a comprehensive understanding of the surface phases of Ag formed in the catalysts, depending on the preparation method.

Specifically, for Ag/γ-Al₂O₃ catalysts prepared in Preparation Examples 1 to 4 and Comparative Examples 1 to 4, which differ in Ag content and preparation method, the absorbance at different wavelengths was measured by UV-Vis spectroscopy, and the results are shown in FIG. 8. Furthermore, the Ag⁰/Ag⁺ ratios in the catalysts, determined based on the Ag content used during synthesis, are summarized in Table 1 below.

FIG. 8 shows the absorbance at different wavelengths measured by UV-Vis spectroscopy and the Ag⁰/Ag⁺ ratio in Ag/γ-Al₂O₃ catalysts prepared in one Preparation Example of the present inventive concept and one Comparative Example.

TABLE 1

Ag⁰/Ag⁺ ratio

| Ag Content | Agₛ/γ-Al₂O₃ | Ag_{w}/γ-Al₂O₃ |
|---|---|---|
| 1 wt. % | 0.99 | 0.47 |
| 2 wt. % | 0.93 | 0.58 |
| 3 wt. % | 1.11 | 0.59 |
| 5 wt. % | 1.09 | 0.83 |

As shown in FIG. 8, the UV-Vis spectrum contains five absorption bands, which correspond to silver cations (Ag⁺, 220 nm), partially oxidized silver clusters (Agₙ^{δ+}, 255 nm), metallic silver clusters (Agₙ⁰, 310 and 360 nm), and bulk silver nanoparticles (Ag_{NPs}, 400 nm). However, Ag₂O particles are difficult to detect by UV-Vis spectroscopy.

As discussed above, in the case of catalysts with an Ag content of 1 wt. %, the Ag_{w}/γ-Al₂O₃ catalyst exhibited significant consumption of terminal hydroxyl groups (—OH), leading to the formation of Ag oxide species. As a result, as shown in FIG. 8 and Table 1, the 1 wt. % Ag_{w}/γ-Al₂O₃ catalyst exhibited a high proportion of Ag⁺ species (Ag⁰/Ag⁺=0.47).

In contrast, the 1 wt. % Agₛ/γ-Al₂O₃ catalyst which exhibited relatively less consumption of terminal hydroxyl groups confirmed the formation of metallic Ag species. Accordingly, as shown in FIG. 8 and Table 1, the 1 wt. % Agₛ/γ-Al₂O₃ catalyst exhibited a higher proportion of metallic Ag species (Ag⁰/Ag⁺=0.99) compared to the 1 wt. % Ag_{w}/γ-Al₂O₃ catalyst.

Also, as shown in FIG. 8, the consumption of terminal hydroxyl groups in Ag_{w}/γ-Al₂O₃ was greater when the Ag content increased from 0 wt. % to 1 wt. % than from 1 wt. % to 2 wt. %. Therefore, at higher Ag contents, Ag_{w}/γ-Al₂O₃ tends to interact more with metallic Ag than with terminal hydroxyl groups, thereby facilitating the formation of metallic Ag species. Consequently, the Ag⁰/Ag⁺ ratio of Ag_{w}/γ-Al₂O₃ gradually increased from 0.47 to 0.83.

In contrast, Agₛ/γ-Al₂O₃ maintained a high proportion of metallic Ag species, as the terminal hydroxyl groups did not significantly decrease with increasing Ag content. Accordingly, the Ag⁰/Ag⁺ ratio of Agₛ/γ-Al₂O₃ was observed in the range of 0.93 to 1.11.

These results suggest that the solid-state impregnation method offers an advantage in generating a higher proportion of metallic Ag species. In particular, the results demonstrate the effectiveness of the solid-state impregnation method in forming metallic Ag species at low Ag contents (e.g., 1 wt. %).

### Experimental Example 6: Evaluation of Catalytic Activity

Metallic Ag species in Ag-based catalysts are widely known to exhibit catalytic activity in oxidation reactions of ammonia (NH₃), formaldehyde (HCHO), and carbon monoxide (CO).

Accordingly, CO oxidation was performed using a probe reaction to evaluate the oxidation performance of the Ag/γ-Al₂O₃ catalyst prepared according to the present inventive concept. To assess the catalytic activity under more realistic feed gas conditions, the following humid conditions were used: 500 ppm CO, 5% O₂, 5% H₂O, and the balance N₂.

The catalytic activity results are shown in FIG. 9.

FIG. 9 is a graph showing the CO oxidation performance of silver-alumina catalysts prepared in one Preparation Example of the present inventive concept and one Comparative Example, indicating the CO conversion (%) as a function of temperature.

As shown in FIG. 9, the Agₛ/γ-Al₂O₃ catalyst prepared by the solid-state impregnation method according to the present inventive concept exhibited superior CO oxidation performance compared to the Ag_{w}/γ-Al₂O₃ catalyst prepared by the conventional wet impregnation method. In particular, at the temperature (T₅₀) at which 50% CO conversion is achieved, the Agₛ/γ-Al₂O₃ catalyst according to the present inventive concept exhibited a T₅₀ of 270° C., which is 70° C. lower than that of the Ag_{w}/γ-Al₂O₃ catalyst prepared by the conventional wet impregnation method (T₅₀₌₃₄₀° C.). This indicates that the Agₛ/γ-Al₂O₃ catalyst can achieve the same catalytic activity at a significantly lower temperature, demonstrating improved energy efficiency.

Moreover, the catalytic activity was also evaluated for the NH₃ oxidation reaction under the following conditions: 200 ppm NH₃, 5% O₂, 5% H₂O, and the balance N₂, and the results are shown in FIG. 10.

FIG. 10 is a graph showing the NHs oxidation activity performance of silver-alumina catalysts prepared in one Preparation Example of the present inventive concept and one Comparative Example, indicating the NH₃ conversion (%) as a function of temperature.

As shown in FIG. 10, the Ag_{w}/γ-Al₂O₃ catalyst prepared by the conventional wet impregnation method exhibited negligible oxidation performance, with NH₃ conversion ratio of below 10% even as the reaction temperature increased from 200° C. to 500° C. In contrast, the Agₛ/γ-Al₂O₃ catalyst prepared by the solid-state impregnation method according to the present inventive concept demonstrated excellent oxidation performance in NH₃ oxidation.

These results suggest that the Agₛ/γ-Al₂O₃ catalyst prepared by the solid-state impregnation method according to the present inventive concept facilitates the formation of metallic Ag species, thereby exhibiting superior catalytic activity.

In addition, the following experiment was conducted to investigate the change in CO oxidation activity depending on Ag content.

Specifically, CO oxidation was performed using a probe reaction for the Ag/γ-Al₂O₃ catalysts prepared in Preparation Examples 1 to 4 and Comparative Examples 1 to 4. To evaluate the catalytic activity under more realistic feed gas conditions, the following humid conditions were used: 500 ppm CO, 5% O₂, 5% H₂O, and the balance N₂.

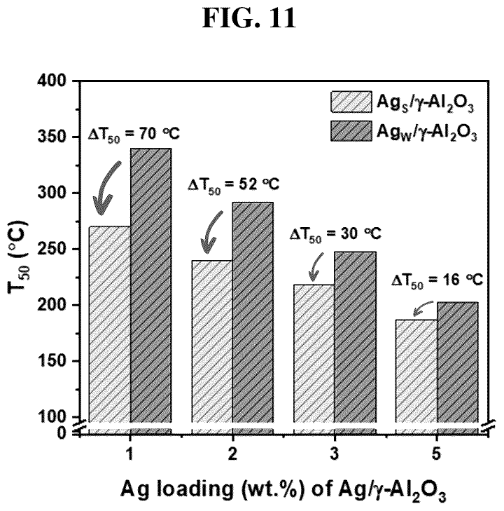

Subsequently, the temperature (T₅₀) at which 50% CO conversion ratio was achieved was measured for the Ag/γ-Al₂O₃ catalysts, and the results are shown in FIG. 11.

FIG. 11 is a graph showing the temperature (T₅₀) at which 50% CO conversion ratio is achieved for the silver-alumina catalysts prepared in the Preparation Examples of the present inventive concept and Comparative Examples. In FIG. 11, the x-axis represents the Ag content in the Ag/γ-Al₂O₃ catalysts, while the y-axis represents the corresponding T₅₀ values.

As shown in FIG. 11, the Agₛ/γ-Al₂O₃ catalysts prepared by the solid-state impregnation method according to the present inventive concept exhibit lower T₅₀ values than the Ag_{w}/γ-Al₂O₃ catalysts prepared by the conventional wet impregnation method, even as the Ag content increases. This indicates that the Agₛ/γ-Al₂O₃ catalysts exhibit superior CO oxidation performance over the Ag_{w}/γ-Al₂O₃ catalysts.

It is to be understood that the embodiments of the present inventive concept disclosed in the specification and drawings are provided as specific examples to facilitate understanding, and are not intended to limit the scope of the inventive concept. It will be apparent to those skilled in the art to which the inventive concept pertains that various modifications and changes may be made to these embodiments without departing from the spirit and scope of the inventive concept.

What is claimed is:

1. A catalyst comprising crystalline silver (Ag) formed on a gamma alumina support and having an Ag⁰/Ag⁺ ratio of 0.9 or higher.

2. The catalyst according to claim 1, wherein the content of Ag in the catalyst ranges from 0.1 wt. % to 5 wt. %.

3. The catalyst according to claim 1, wherein the catalyst has a metallic Ag phase.

4. The catalyst according to claim 1, wherein the catalyst has d-spacings in the ranges of 0.203 nm to 0.205 nm and 0.235 nm to 0.237 nm.

5. The catalyst according to claim 1, wherein the catalyst exhibits diffraction peaks at 38 to 39°, 44 to 45°, 64 to 65°, and 77 to 78° in X-ray diffraction analysis.

6. The catalyst according to claim 1, wherein the catalyst exhibits CO and NH₃ oxidation performance of 50% or higher at 300° C. when the Ag content is 1 wt. %.

7. A method for preparing a catalyst, the method comprising the steps of:
grinding and mixing gamma alumina (γ-Al₂O₃) and a metallic silver (Ag) precursor together in the solid phase; and
calcination the mixture of gamma alumina and the metallic silver (Ag) precursor at a temperature above the melting point of the metallic silver (Ag) precursor to prepare a catalyst comprising crystalline silver (Ag) formed on a gamma alumina support.

8. The method for preparing a catalyst according to claim 7, wherein the content of the metallic silver (Ag) precursor ranges from 0.1 wt. % to 5 wt. % based on the total weight of the mixture.

9. The method for preparing a catalyst according to claim 7, wherein the metallic silver (Ag) precursor is converted into a molten salt in the calcination step.

10. The method for preparing a catalyst according to claim 7, wherein the method results in a smaller reduction in the content of terminal hydroxyl groups on gamma alumina than a water-based wet method.

11. The method for preparing a catalyst according to claim 7, wherein the crystalline silver (Ag) formed in the calcination step is present in a metallic phase and has an Ag⁰/Ag⁺ ratio of 0.9 or higher.

12. The method for preparing a catalyst according to claim 7, further comprising the step of drying the mixture of gamma alumina and the metallic silver (Ag) precursor prior to the calcination.

13. The method for preparing a catalyst according to claim 7, wherein the calcination is carried out under static air conditions.

14. The method for preparing a catalyst according to claim 7, wherein the calcination is carried out at a temperature ranging from 450° C. to 600° C.

15. The method for preparing a catalyst according to claim 7, further comprising the step of pelletizing the calcinated catalyst powder.
